(19) United States
(12) Patent Application Publication
(10) Pub. No.: US 2006/0277282 A1
(43) Pub. Date: Dec. 7, 2006

(54) Federated scheduling method and system

(75) Inventors: James E. Christensen, Cortlandt Manor, NY (US); Stephen E. Levy, Honolulu, HI (US); Edith H. Stern, Yorktown Heights, NY (US); Robert J. Sundstrom, Cary, NC (US); Jeremy Sussman, Bedford Hills, NY (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: International Business Machines Corporation, Armonk, NY (US)

(21) Appl. No.: 11/143,694

(22) Filed: Jun. 2, 2005

(51) Int. Cl. G06F 15/173

(52) U.S. Cl. 709/223

(57) ABSTRACT

Disclosed above is a system and method for coordinating the exchange of information about an event. Specifically, the invention incorporates the use of a federated broker in the form of either a monolithic server or a network of servers for exchanging of information about an event between two or more entities. The broker is adapted to receive information about an event, including up-dates and presentation material, store the information and disseminate the information to other interested entities. Communication between the broker and the two entities is via a contact. For those entities maintaining a calendar system, the contact functions as an interchange agent that facilitates communications between the calendar system of the entity and the server. This interchange agent may be an automated mechanism.

### BACKGROUND OF THE INVENTION

1. Field of the Invention

The invention generally relates to electronic scheduling systems, and particularly, to a federated scheduling method and system that interoperates with disparate electronic calendar and scheduling systems.

2. Description of the Related Art

Electronic scheduling applications and calendars are used to schedule and to keep track of notable events. Oftentimes organizations will maintain the same calendar and scheduling system across the organization so that the scheduling of events for individuals and/or resources within the organization can be easily synchronized. However, because no uniform style of electronic calendar and scheduling application exists, coordinating the exchange of information about events with participants and/or resources from different organizations that employ disparate calendar and scheduling systems remains problematic.

### SUMMARY OF THE INVENTION

In view of the foregoing, the present invention discloses a system and method for coordinating an exchange of information about an event. The system and method of the invention incorporates the use of a federated broker in the form of either a monolithic server or a network of servers for exchanging information about an event between two or more entities. Communication between the federated broker and the two entities is via a contact (identified by a contact address). For those entities that maintain a calendar system, the contact is an interchange agent that facilitates communication between the calendar system and the broker.

More specifically, in one embodiment of the system a monolithic server coordinates the exchange of information about an event between two or more entities. The server comprises a receiver, a processor, a data storage device and a transmitter. The receiver is adapted for receiving an initial indication of an event containing information about the event from a first entity. The information about the event can include a time, a date, a location, a conference call number, a session initiation protocol uniform resource locator, a list of entities with an interest in the event, a list of attendees of the event, presentation material for the event, resources available for the event, an entity-specific identifier for the event and an agenda for the event. The processor is adapted to review the information about the event in order to identify one or more other entities (e.g., a second entity) that have an interest in the event and to determine contacts (and specifically contact addresses) for the first and second entities. For those entities that have a calendar system, the contact is a calendar system interchange agent that is used to facilitate communication between the calendar system and the broker. The processor is further adapted to associate the event with an event identifier. The information is stored in a data storage device and retrievable by reference to the event identifier. The transmitter is adapted to send an acknowledgement to the contact (and specifically, to the contact address) of the first entity and also to disseminate the information about the event to the contact of the second entity (e.g., via the contact address) or any other entity identified as having an interest in the event. Communications sent by the transmitter about an event will reference the event identifier for the event.

In addition to providing a means for passing initial information about an event from one entity to another, the system of the invention also provides a means for updating the information.

For example, the receiver can also be adapted to receive additional information (e.g., up-dates) about the event from either the first entity, the second entity, or any other entity with an interest in the event. The additional information can include new information (e.g., a time, a date, a location, a conference call number, a session initiation protocol uniform resource locator, a list of entities with an interest in the event, a list of attendees of the event, presentation material for the event, resources available for the event, an agenda for the event, an entity-specific identifier for the event, etc.) or changes to the information provided in the initial indication of the event. The additional information is stored in the data storage device with the information provided in the initial indication and the transmitter disseminates the additional information. Additionally, the processor can be adapted to identify conflicts between the information in the initial indication and the additional information. If conflicts are identified, the transmitter will send an indication of the conflicts to the first entity, the second entity, or any other entity identified as having an interest in the event.

The processor may also be adapted to review both the information in the initial indication and any additional information received in order to identify any entity-specific identifiers that have been assigned to the event by the first entity, the second entity, or any other entity identified as having an interest in the event. The processor will associate any entity-specific identifiers for an event with the event identifier for the event, so that any communications received relating to the event that do not contain a reference to the event identifier, but do contain a reference to the entity specific identifier can be cross-referenced. However, if any additional information is received without reference to a previously identified entity-specific identifier and without reference to the event identifier, the transmitter will return an error message to the entity that sent the additional information.

Another embodiment of system is similar to the system described above, however, instead of a monolithic server, the functional features of the server are divided amongst a network of servers that in aggregate comprise at least one receiver, at least one processor, at least one data storage device, and at least one transmitter. For example, two or more of the entities within the system can each be associated with a corresponding server and each corresponding server can comprise a receiver, processor, a data storage device, and a transmitter. Regardless of whether these functional features (i.e., receiver, processor, data storage device, and transmitters) of the system are located in a central (i.e., monolithic) server or distributed amongst a network of servers, they are adapted to perform the same functions as described above.

In an embodiment of the method of the invention the exchange of information about an event is coordinated between entities. The method comprises first receiving an initial indication of the event from a first entity. The initial indication will include information about the event. The information can include a time, a date, a location, a conference call number, a session initiation protocol uniform resource locator, a list of entities with an interest in the event, a list of attendees of the event, presentation material for the event, resources available for the event, an entity-specific identifier for the event and an agenda for the event. This information is reviewed in order to identify other entities having an interest in the event (e.g., a second entity), to identify other items about the event (e.g., date, time, etc.) and to determined contacts (and specifically contact addresses) for each entity having an interest in the event (e.g., the first entity and the second entity). For entities having a calendar system, the contact is an interchange agent that facilitates communication between the calendar system and the broker. The event is associated with an event identifier and the information about the event is stored such that it may be retrieved by reference to the event identifier. Additionally, the information is disseminated, including a reference to the event identifier, to the contact of the second (via the contact address) and to any other entity having an interest in the event. An acknowledgement of the initial indication is also sent back to the first entity and will include a reference to the event identifier.

In addition to providing processes for passing on initial information about an event from one entity to another, the method of the invention also provides processes for updating the information. For example, additional information about the event can be received from the first entity, the second entity, or any other entity having an interest in the event. The additional information can include new information (e.g., a time, a date, a location, a conference call number, a session initiation protocol uniform resource locator, a list of entities with an interest in the event, a list of attendees of the event, presentation material for the event, resources available for the event, an agenda for the event, an entity-specific identifier for the event, etc.) or changes to the information provided in the initial indication of the event. The additional information is stored with the initial information and disseminated. Additionally, conflicts between the information in the initial indication and the additional information can be identified and a notification of the conflicts can be sent to all entities identified as having an interest in the event.

In order to facilitate the efficient exchange of information, the initial information and any additional information received about the event can be reviewed in order to identify any entity-specific identifiers assigned to the event by the first entity, the second entity, or any other entity identified as having an interest in the event. The entity-specific identifiers will be associated with the event identifier so that when any future additional information is received with a reference to an entity-specific identifier and without a reference to the event identifier, the entity-specific identifier can be cross-referenced. However, if additional information is received without reference to a previously identified entity-specific identifier and without reference to the event identifier, an error message will be returned to the entity (e.g., first or second entity) from which the additional information was received.

### BRIEF DESCRIPTION OF THE DRAWINGS

The invention will be better understood from the following detailed description with reference to the drawings, in which:

FIG. 1 is a schematic diagram illustrating one embodiment of a system of the invention;

FIG. 2 is a schematic diagram illustrating another embodiment of a system of the invention; and,

FIGS. 3-4 are schematic flow diagrams illustrating an embodiment of a method of the invention.

### DETAILED DESCRIPTION OF PREFERRED EMBODIMENTS OF THE INVENTION

The present invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention. The examples used herein are intended merely to facilitate an understanding of ways in which the invention may be practiced and to further enable those of skill in the art to practice the invention. Accordingly, the examples should not be construed as limiting the scope of the invention.

As discussed above, enterprise-specific calendar domains (i.e., calendar systems) make it possible for individual members of the enterprise to coordinate calendar entries, for example, by providing a system that allows communication and coordination between individual electronic calendars and a shared calendar. However, no effective method and system has been developed for coordinating the exchange of information about events in which resources and/or participants are associated with different organizations employing disparate calendar and scheduling systems. The present invention discloses a system which incorporates the use of a federated broker in the form of either a monolithic server or a network of servers for exchanging information about an event between two or more entities, and specifically, for exchanging the information when at least one of the entities maintains a calendar system. Communication between the federated broker and the entities is via a contact through a contact address and for those entities maintaining a calendar system, the contact is an interchange agent that facilitates communication with a scheduling component of the calendar system. While individuals will make decisions regarding when and how meetings will be scheduled and rescheduled, who will be invited to attend a meeting, and which invitations to accept, reject, delegate attendance, etc., the method and system of the present invention allows for an exchange of information between disparate calendar systems and can further record and maintain information regarding an event so that consensus about relevant meeting details is tracked and accessible for all participants regardless of the entity (e.g., business entities, organizations, associations, individuals, groups, etc.) to which they belong.

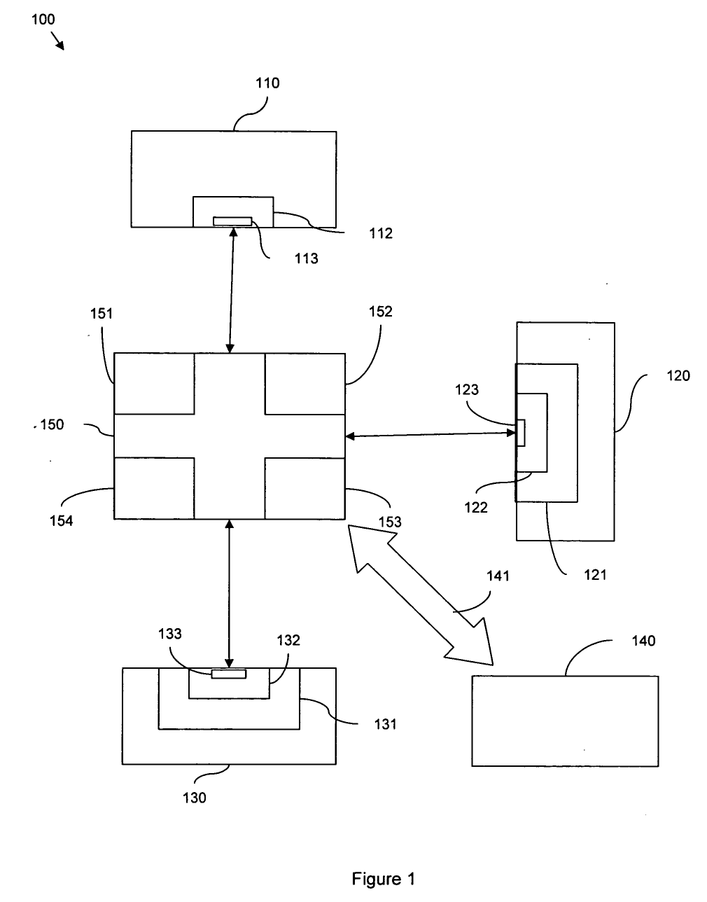

FIG. 1 illustrates one embodiment of the system 100 which incorporates the use of a monolithic server 150 that is in communication with two or more entities (e.g., a first entity 110, a second entity 120, a third entity 130, etc. The monolithic server 150 coordinates the exchange of information about an event between two or more entities (e.g., first entity 110 and second entity 120) within the system 100, when at least one of the entities maintains an entity-specific calendar system (e.g., see calendar system 121 of second entity 120 or a calendar system 131 of third entity 130). The server 150 comprises a receiver 151, a processor 152, a data storage device 153 and a transmitter 154. The receiver 151 is a component adapted for receiving from an entity (e.g., business entity, company, corporation, organization, association, individual, group, etc.) an initial indication of an event (e.g., a meeting, a conference, a telephone conference, a convention, seminar, a party, an appointment, etc.) that contains information about the event. The indication can be received in the form of an e-mail, recorded message, text message, etc., for example, from the first entity 110. The information about the event can include a time, a date, a location, a conference call number, a session initiation protocol uniform resource locator, a list of at least two entities with an interest in the event, a list of attendees of the event, presentation material for the event, resources available for the event, an entity-specific identifier for the event and an agenda for the event. The processor 152 is adapted to review (e.g., using text analysis software) the initial indication of the event to identify one or more other entities (e.g., a second entity 120) that have an interest in the event, to determine contacts 112, 122, 132 and, specifically, contact addresses for the first entity 110 and any other entity having an interest in the event (e.g., the contact addresses 113 and 123 of first and second entities 110 and 120), and to identify any other relevant information about event. Entities having an interest in an event may include organizations with members attending the event, associations providing resources for the event, etc. A contact address 113, 123, 133 is an address through which the server 150 may communicate with an entity contact 112, 122, 132 and may include an email address, a telephone number, etc. For entities that have a calendar system (e.g., calendar system 121 of second entity 120 or calendar system 131 of third entity 130), the contact address (e.g., 123 or 133) is used to communicate with the calendar system (e.g., 121 or 131), and specifically, with a contact 122, 132 that functions as an interchange agent between the calendar system of the entity and the server 150. This interchange agent may be an individual or an automated mechanism. The processor 152 is further adapted to associate the event with a coordinated event identifier (e.g., a federated system identification number, a reference number, a file name, etc.) that is used to identify and retrieve the information, when it is stored in the data storage device 153. The transmitter 154 is adapted to send an acknowledgement with a reference to the event identifier to the contact address 113 of the first entity 110 and also to disseminate the information about the event, including a reference to the event identifier, to the contact address 123 of the second entity 120 or to the contact address of any other entity identified as having an interest in the event (e.g., contact address 133 of third entity 130). The transmitter 154 can communicate with the contact 112, 122, 132 by sending the information or acknowledgement directly by e-mail, by e-mail with an iCal attachment, by automated telephone message, by text message, etc. Alternatively, the acknowledgement or information may be indirectly provided to the contact. For example, an e-mail, e-mail with an iCal attachment, automated telephone message, text message, etc may be sent to the contact address 113, 123, 133 with a link (e.g., to a uniform resource locator) and an indication that a message is waiting for the contact on the server. It should be noted that the monolithic server 150 may be physically separate from each of the entities participating in the system (as illustrated in FIG. 1). Alternatively, the server 150 may be maintained within and by one entity that has a calendar system. For example, the server 150 may be maintained by the second entity 120 such that all communications with the server 150 are coordinated via the interchange agent 122 for the second entity 120 (i.e., via contact 122 at contact address 123).

In addition to providing a means for passing initial information about an event from one entity to another, the system of the invention also provides a means for updating the information.

For example, the receiver 151 can also be adapted to receive additional information (e.g., up-dates) about the event from either the first entity 110, the second entity 120, or any other entity with an interest in the event (e.g., the third entity 130). The additional information can include new information (e.g., a time, a date, a location, a conference call number, a session initiation protocol uniform resource locator, a list of entities with an interest in the event, a list of attendees of the event, presentation material for the event, resources available for the event, an agenda for the event, an entity-specific identifier for the event, etc.) or changes to the information provided in the initial indication of the event. The data storage device 153 stores the additional information with the information provided in the initial indication and the transmitter 154 disseminates the additional information along with a reference to the event identifier. Additionally, the processor 152 can be adapted to identify conflicts between the information in the initial indication and the additional information. If conflicts are identified, the transmitter 154 will send an indication of the conflicts to the first entity 110, the second entity 120, and to any other entity identified as having an interest in the event (e.g., the third entity 130).

The processor 152 may also be adapted to review (e.g., by text analysis) both the information in the initial indication and any additional information to identify any entity-specific identifiers (e.g., identification numbers, file names, reference numbers, etc.) that have been assigned to the event by the first entity 110, the second entity 120, or any other entity identified as having an interest in the event (e.g., the third entity 130). The processor 152 will associate any identified entity-specific identifiers with the event identifier so that any communications received by the receiver 151 that relate to the event but do not contain a reference to the event identifier may be processed. For example, additional information without a reference to the event identifier that contains a reference to a previously identified entity specific identifier can be cross-referenced. This allows calendar systems not adapted to process receipt of the event identifier to nevertheless participate in this cross domain scheduling, using their internal ID (i.e., their entity-specific event identifier). However, if any additional information is received without reference to a previously identified entity-specific identifier and without reference to the event identifier, the transmitter 154 will communicate an error message to the entity that sent the additional information.

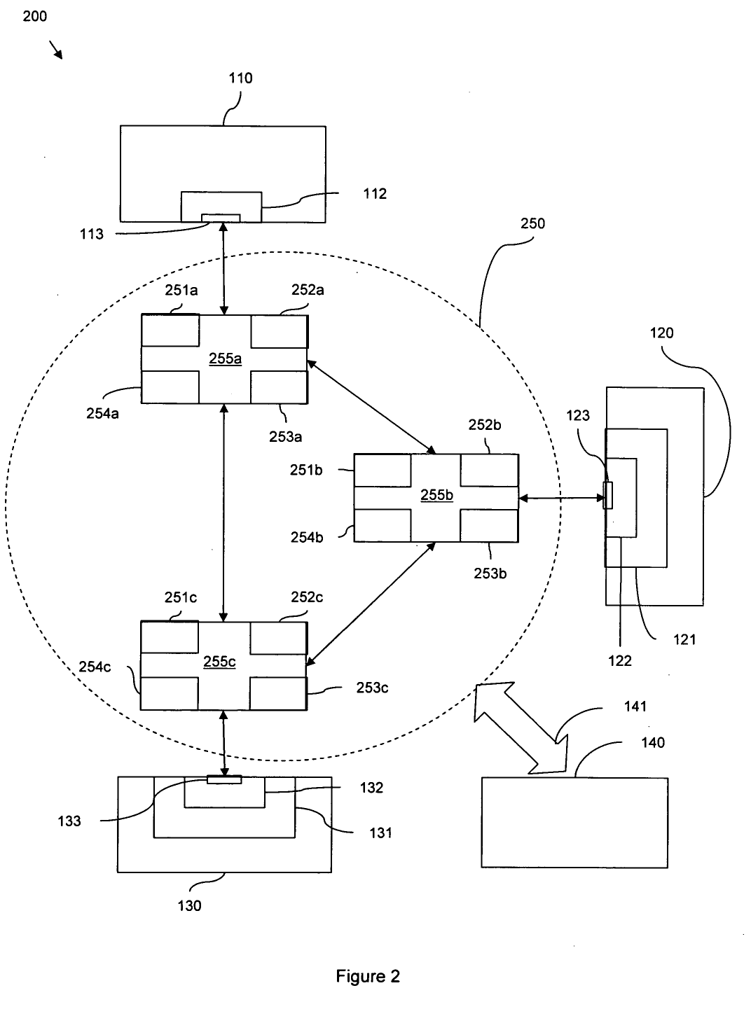

Referring to FIG. 2, another embodiment of the invention comprises a system 200 similar to the system 100 described above, however, instead of a monolithic server 150, as illustrated in FIG. 1, the functional features of the server are divided amongst a set 250 of servers (e.g., network of servers 255a, 255b, 255c) that in total comprise at least one receiver (e.g., 251a, 251b, 251c), at least one processor (e.g., 252a, 252b, 252c), at least one data storage device (e.g., 253a, 253b, 253c), and at least one transmitter (e.g., 254a, 254b, 254c). Note the functional components of the server network 250 may be distributed in any number of ways up to and including a peer-to-peer configuration, as illustrate in FIG. 2, in which a separate server 255a, 255b, 255c is associated with each entity 210, 220, 230, respectively, and each server 255a-c comprises a receiver 251a-c, processor 252a-c, a data storage device 253a-c, and a transmitter 254a-c. Regardless of whether these functional components (i.e., receiver, processor, data storage device, and transmitter) of the server network 250 are located in a monolithic server 150, as illustrate in FIG. 1, or distributed amongst a network of servers 250, they are adapted to perform the same functions as described above. In a peer-to-peer network 250 of servers, the servers 255a, 255b, 255c can be physically the same servers or different servers than the servers that run an automated interchange agent (i.e., contact 122, 132 used to communicate between the calendar system 121, 131 of the entity 120, 130 and the system of the invention). Thus, the system 200 of the invention does not require the use of a central server that is distinct from the servers used to run an entity's calendar system or automated interchange agent.

In addition to the features described above, the system 100, 200 of the invention may further comprise an interface 141 that other entities (e.g., fourth entity 140) or individuals associated with the system entities 110, 120, 130 with access (either limited or unlimited) to the information stored in the data storage device 153.

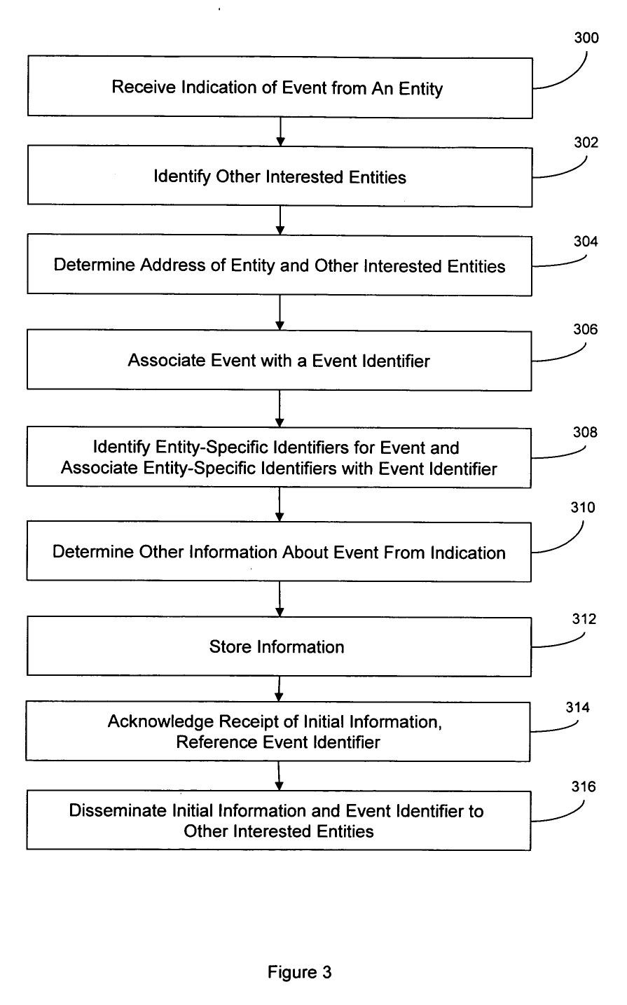

Referring to FIG. 3 in combination with FIGS. 1 and 2, in an embodiment of the method of the invention an exchange of information about an event is coordinated between entities (e.g., a first entity 110, a second entity 120, or a third entity 130), when at least one of the entities has a calendar system (e.g., see calendar system 121 of second entity 120 or calendar system 131 of third entity 130). The method comprises first receiving (within a server or network of servers) an initial indication of the event from a first entity 110 (300). An entity can be a business entity, company, corporation, organization, association, individual, group, etc. An event can be a meeting, a conference, a telephone conference, a convention, seminar, a party, an appointment, etc. The initial indication will include information about the event and can be received in the form of an e-mail, recorded message, text message, etc. The information about the event can include a time, a date, a location, a conference call number, a session initiation protocol uniform resource locator, a list of entities with an interest in the event, a list of attendees of the event, presentation material for the event, resources available for the event, an entity-specific identifier for the event and an agenda for the event. This information contained in the initial indication is reviewed (e.g., by text analysis) in order to identify other entities having an interest in the event (e.g., a second entity 120 (302), to determined contact addresses for each entity having an interest in the event (e.g., the first entity 110 and the second entity 120) (304), and to determine other information about the event (e.g., date, time, etc.) (310). Additionally, a review of the information provided in the initial indication can be used to identify any entity-specific identifiers that have been assigned by any of the entities 110, 120, 130 to the particular event and to associate those entity-specific identifiers with the event identifier (308). This allows for cross-referencing if a communication is received without referencing the event identifier.

Contact addresses are those addresses through which the server network 250 may communicate with an entity contact 112, 122, 132 and may include an email address, a telephone number, etc. For entities 120, 130 having a calendar system 121, 131, the contact address 123, 133 is used to communicate with the calendar system, and specifically, with a contact 122, 132 that functions as an interchange agent between the calendar system 121, 131 of the entity 120, 130 and the server 150 or server network 250, depending upon the system embodiment. This interchange agent may be an individual or automated mechanism.

The event is also associated with a coordinated event identifier (e.g., a federated system identification number, a reference number, a file name, etc.) (306) and the information about the event is stored (e.g., in a data storage device 153, 253a-c within the server or network of servers) such that it may be identified and retrieved by reference to the event identifier (312). Once the information is stored (312), an acknowledgement of the initial indication is sent back to the first entity 110 along with a reference to the event identifier (314). Additionally, the information is disseminated, with a reference to the event identifier, to the contact address of the second entity 120 or to the contact address of any other entity having an interest in the event (e.g., contact address 133 of third entity 130) (316). Specifically, the acknowledgement and/or information may be communicated to the appropriate contact address directly by e-mail, by e-mail with an iCal attachment, by automated telephone message, by text message, etc. Alternatively, an e-mail, e-mail with an iCal attachment, automated telephone message, text message, etc., can be sent to the contact address 113, 123, 133 with a link (e.g., to a uniform resource locator) and an indication that a message is waiting on the system server.

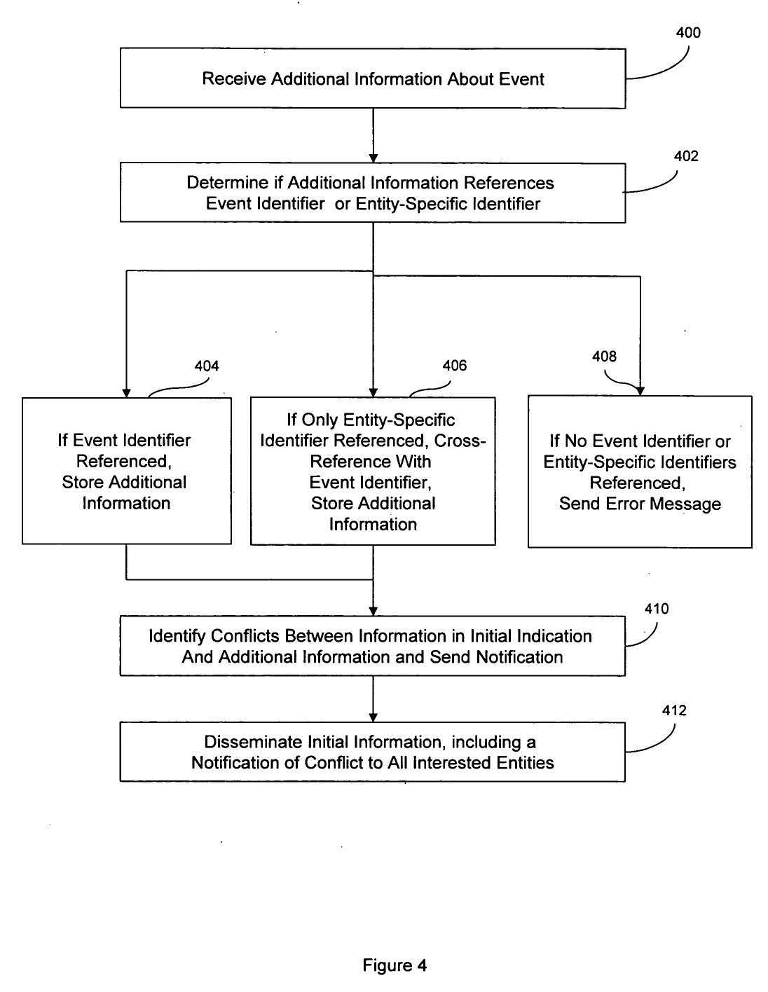

Referring to FIG. 4, in addition to providing processes for passing on initial information about an event from one entity to another, the method of the invention also provides processes for updating the information. For example, additional information about the event can be received from the first entity 110, the second entity 120, or any other entity having an interest in the event (e.g., third entity 130) (400). The additional information can include new information (e.g., a time, a date, a location, a conference call number, a session initiation protocol uniform resource locator, a list of entities with an interest in the event, a list of attendees of the event, presentation material for the event, resources available for the event, an agenda for the event, an entity-specific identifier for the event, etc.) or changes to the information provided in the initial indication of the event. The additional information is stored (404, 406) and disseminated (412). Additionally, conflicts between the information in the initial indication and the additional information can be identified and a notification of the conflicts can be sent to first entity 110, the second entity 120 and any other entity identified as having an interest in the event (e.g., the third entity 130) (410).

In order to facilitate the efficient exchange of information, the initial information and any additional information received about the event can be reviewed (e.g., by text analysis) in order to identify any entity-specific identifiers (e.g., identification numbers, file names, reference numbers, etc.) assigned to the event by the first entity 110, the second entity 120, or any other entity identified as having an interest in the event (e.g., the third entity 130), as described above at process (308). The entity-specific identifiers are associated with the event identifier so that when any future additional information is received with a reference to an entity-specific identifier and without a reference to the event identifier, the entity-specific identifier can be cross-referenced with the event identifier and the additional information can be appropriately stored (404) and disseminated (412). However, if additional information is received without reference to a previously identified entity-specific identifier and without reference to the event identifier, an error message will be returned to the entity (e.g., first or second entity) from which the additional information was received (408). Additionally, the method may include allowing other entities (e.g., fourth entity 140) or individuals associated with the system entities 110, 120, 130 with access (either limited or unlimited) to the information stored in the data storage device 153 about the event.

The embodiments of the system and method described above allow calendaring to be coordinated when those involved do not have a common calendaring domain. For example, units of a single business operating different calendaring systems can use the system disclosed to schedule and coordinate interactions. Also, different businesses with different calendaring systems can engage in cross domain scheduling. For example, a group of businesses, where at least one has a calendaring system can engage in cross domain scheduling. Additionally, the system and method disclosed supports calendaring across the lifecycle of an interaction. For example, typically scheduled interactions begin with very little associated data (e.g., the identities of the entities wishing to meet). Over time, more information is determined (e.g., the dates, locations, participants, etc.). The system disclosed supports this lifecycle by allowing each entity to use its own system for changes. Furthermore, the system and method disclosed allows associated information, such as presentation materials, to be shared among the entities participating in an event (e.g. presentation materials may be shared through the system). For example, company A may use the system to share presentation materials for an upcoming meeting with company B, if company A does not know all the attendees expected from Company B and so cannot directly transmit these presentation materials to those attendees. Specifically, the presentation materials can be delivered from Company A to the interchange agent (contact) of the calendaring system for Company B, which can then make available these materials to the invited members of Company B. The calendaring interaction and the use of the coordinated event identifier provides a pipeline for the exchange of associated materials to exactly the correct audience.

Therefore, disclosed above is a system and method for coordinating the exchange of information about an event. Specifically, the invention incorporates the use of a federated broker in the form of either a monolithic server or a network of servers for exchanging of information about an event between two or more entities. The broker is adapted to receive information about an event, including up-dates and presentation material, store the information and disseminate the information to other interested entities. Communication between the broker and the two entities is via a contact through a contact address. For those entities maintaining a calendar system, the contact is an interchange agent used to facilitate communication between the entity's calendar system and the federated broker. This interchange agent may be an automated mechanism. While the invention has been described in terms of preferred embodiments, those skilled in the art will recognize that the invention can be practiced with modification within the spirit and scope of the appended claims.

What is claimed is:

1. A system for coordinating an exchange of information about an event, said system comprising:
a server in communication with a first contact of a first entity and a second contact of a second entity, wherein at least one of said first entity and said second entity maintains a calendar system which is in communication with said server via a corresponding one of said first contact and said second contact, and wherein said server comprises:
a receiver that is adapted to receive an initial indication of said event containing said information about said event from said first entity;
a processor, wherein said processor is adapted to review said information in order to identify said second entity and to determine a first contact address for said first contact and a second contact address for said second contact and wherein said processor is further adapted to associate said event with an event identifier;
a data storage device adapted for storing said information such that said information is retrievable by reference to said event identifier; and
a transmitter adapted to disseminate said information, including a reference to said event identifier, to said second contact address.

2. The system of claim 1, wherein said transmitter is further adapted to send to said first contact address an acknowledgement with a reference to said event identifier.

3. The system of claim 1, wherein said receiver is further adapted to receive additional information about said event from at least one of said first entity and said second entity,
wherein said data storage device is further adapted to store said additional information, and
wherein said transmitter is further adapted to disseminate said additional information, including said reference to said event identifier.

4. The system of claim 3, wherein said information about said event and said additional information about said event comprise at least one of a time, a date, a location, a conference call number, a session initiation protocol uniform resource locator, a list of at least two entities with an interest in said event, a list of attendees of said event, presentation material for said event, resources available for said event, and an agenda for said event.

5. The system of claim 4, wherein said processor is further adapted:
to identify an entity-specific identifier assigned to said event by one of said first entity and said second entity,
to associate said entity-specific identifier with said event identifier, and
to cross-reference said entity-specific identifier with said event identifier, when said additional information is received by said receiver with a reference to said entity-specific identifier and without a reference to said event identifier.

6. The system of claim 5, wherein said transmitter is further adapted to return an error message to said one of said first entity and said second entity, when said additional information is received without reference to said entity-specific identifier and without reference to said event identifier.

7. The system of claim 4, wherein said processor is further adapted to identify conflicts between said information in said initial indication and said additional information, and wherein said transmitter is further adapted to send an indication of said conflicts to at least one of said first entity and said second entity.

8. The system of claim 1, wherein one of said first entity and said second entity maintains said server such that communication with said server is coordinated via a corresponding one of said first contact and said second contact.

9. A system for coordinating an exchange of information about an event, said system comprising:
a set of servers in communication with a first contact of a first entity and a second contact of a second entity, wherein at least one of said first entity and said second entity maintains a calendar system which is in communication with said set of servers via a corresponding one of said first contact and said second contact and wherein said set of servers comprises:
at least one receiver adapted to receive an initial indication of said event containing said information about said event from said first entity;
at least one processor, wherein said processor is adapted to review said information in order to identify said second entity and to determine a first contact address for said first contact and a second contact address for said second contact, and wherein said processor is further adapted to associate said event with an event identifier;
at least one data storage device adapted for storing said information such that said information is retrievable by reference to said event identifier; and
at least one transmitter adapted to disseminate said information, including a reference to said event identifier, to said second contact address.

10. The system of claim 9, wherein said transmitter is further adapted to send to said first contact address an acknowledgement with a reference to said event identifier.

11. The system of claim 9, wherein said receiver is further adapted for receiving additional information about said event from one of said first entity and said second entity, wherein said data storage device is further adapted for storing said additional information, and wherein said transmitter is further adapted to disseminate said additional information, with said reference to said event identifier.

12. The system of claim 11, wherein said information about said event and said additional information about said event comprise at least one of a time, a date, a location, a conference call number, a session initiation protocol uniform resource locator, a list of at least two entities with an interest in said event, a list of attendees of said event, presentation material for said event, resources available for said event, and an agenda for said event.

13. The system of claim 11, wherein said processor is further adapted:
to identify an entity-specific identifier assigned to said event by one of said first entity and said second entity,
to associate said entity-specific identifier with said event identifier, and
to cross-reference said entity-specific identifier with said event identifier, when said additional information is received by said receiver with a reference to said entity-specific identifier and without a reference to said event identifier.

14. The system of claim 13, wherein said transmitter is further adapted to return an error message to said one of said first entity and said second entity, when said additional information is received without reference to said entity-specific identifies and without reference to said event identifier.

15. The system of claim 11, wherein said processor is further adapted to identify conflicts between said information in said initial indication and said additional information, and
wherein said transmitter is further adapted to send an indication of said conflicts to said first entity and said second entity.

16. The system of claim 11, wherein at least one server of said set of servers is maintained by at least one of said first entity and said second entity such that communication with said one server is coordinated via a corresponding one of said first contact and said second contact.

17. A method for coordinating an exchange of information about an event, said method comprising:
receiving an initial indication of said event containing said information about said event from a first entity,
reviewing said information to identify a second entity,
determining a first contact and a first contact address for said first entity and a second contact and a second contact address for said second entity in order to communicate with said first entity and said second entity;
associating said event with an event identifier;
storing said information such that said information is retrievable by reference to said event identifier; and
disseminating said information, including a reference to said event identifier, to said second contact address,
wherein at least one of said first entity and said second entity maintains a calendar system and wherein communication with said calendar system is via a corresponding one of said first contact and said second contact.

18. The method of claim 17, further comprising sending an acknowledgement, which references said event identifier, to said first contact address.

19. There method of claim 17, further comprising:
receiving additional information about said event from one of said first entity and said second entity;
storing said additional information; and
disseminating said additional information, including said reference to said event identifier.

20. The method of claim 19, wherein said information and said additional information about said event comprise at least one of a time, a date, a location, a conference call number, a session initiation protocol uniform resource locator, a list of at least two entities with an interest in said event, a list of attendees of said event, presentation material for said event, resources available for said event, and an agenda for said event.

21. The method of claim 15, further comprising:
identifying an entity-specific identifier assigned to said event by one of said first entity and said second entity;
associating said entity-specific identifier with said event identifier; and
wherein said additional information is received with a reference to said entity-specific identifier and without a reference to said event identifier, cross-referencing said entity-specific identifier with said event identifier.

22. The method of claim 21, further comprising when said additional information is received without reference to said entity-specific identifier and without reference to said event identifier, returning an error message to said one of said first entity and said second entity.

23. The method of claim 19, further comprising:
identifying conflicts between said information in said initial indication and said additional information; and
sending a notification of said conflicts to said first entity and said second entity.

24. A method for coordinating an exchange of information about an event, said method comprising:
receiving within a set of servers an initial indication of said event containing said information about said event from a first entity,
reviewing said information to identify a second entity,
determining a first contact and a first contact address for said first entity and a second contact and a second contact address for said second entity in order to communicate with said first entity and said second entity;
associating said event with an event identifier;
storing said information within said set of servers such that said information is retrievable by reference to said event identifier; and
disseminating said information, with a reference to said event identifier, to said second contact address,
wherein at least one of said first entity and said second entity maintains a calendar system and wherein communication with said calendar system is via a corresponding one of said first contact and said second contact.

25. The method of claim 24, further comprising sending an acknowledgement, which references said event identifier, to said first contact address.

26. There method of claim 24, further comprising:
receiving within said set of servers additional information about said event from one of said first entity and said second entity;
storing said additional information; and
disseminating said additional information with said reference to said event identifier.

27. The method of claim 26, wherein said information and said additional information about said event comprise at least one of a time, a date, a location, a conference call number, a session initiation protocol uniform resource locator, a list of entities with an interest in said event, a list of attendees of said event, presentation material for said event, resources available for said event, and an agenda for said event.

28. The method of claim 26, further comprising:
identifying an entity-specific identifier assigned to said event by one of said first entity and said second entity;
associating said entity-specific identifier with said event identifier; and
wherein said additional information is received with a reference to said entity-specific identifier and without a reference to said event identifier, cross-referencing said entity-specific identifier with said event identifier.

29. The method of claim 28, further comprising when said additional information is received without reference to said entity-specific identifier and without reference to said event identifier, returning an error message to said one of said first entity and said second entity.

30. The method of claim 26, further comprising:
identifying conflicts between said information in said initial indication and said additional information; and
sending a notification of said conflicts to said first entity and said second entity.
